(19) United States
(12) Patent Application Publication
(10) Pub. No.: US 2007/0271843 A1
(43) Pub. Date: Nov. 29, 2007

(54) MODULAR, PORTABLE, BOTTOMLESS PLANTER

(76) Inventor: Harriet Kirkpatrick, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/835,827

(22) Filed: Aug. 8, 2007

Related U.S. Application Data
(63) Continuation of application No. 10/807,460, filed on Mar. 22, 2004, now abandoned.
(60) Provisional application No. 60/456,494, filed on Mar. 21, 2003.

(51) Int. Cl. A01G 9/02

(52) U.S. Cl. 47/66.3

(57) ABSTRACT

A modular, bottomless planter comprising a plurality of panels and at least one temporary fastener that is adapted for temporarily attaching at least one of the panels to another of the panels. The planter is configured to be temporarily assembled around the base of a stationary object, such as a mailbox post or tent stake, and filled with plants or other vegetation to produce a pleasing visual effect. In one embodiment of the invention, the planter includes four substantially planar panels that are configured to be stacked when the planter is in a disassembled configuration.

### CROSS REFERENCE TO RELATED APPLICATIONS

This application is a continuation of U.S. application Ser. No. 10/807,460, filed Mar. 22, 2004, which is based on U.S. provisional application Ser. No. 60/456,494, filed Mar. 21, 2003. Both of these applications, which are each entitled “Modular, Portable, Bottomless Planter”, are hereby incorporated by reference in their entirety.

### BACKGROUND OF THE INVENTION

Standard decorative planters currently include a bottom partition and attached sides. To use the planters, a user fills the planters with dirt, fertilizer and plants or flowers as is well known in the relevant field. One problem associated with these prior art planters is that, because they maintain the contents of the planter in a small, constrained space, the contents of the planter commonly dry out, which can kill or otherwise harm the plants or flowers.

Another problem associated with prior art planters is that they are typically, large, heavy, and cumbersome to store and move. This makes it especially difficult to use the planters for temporary uses that require the planters to be moved and stored frequently. Such temporary uses include, for example, uses by event planners, exhibitors, and stylists.

A further disadvantage associated with traditional planters is that, because the side and bottom portions of the planters are permanently attached together in a fixed configuration, the size and shape of the planters can not be changed as needed. As a result, event planners and other individuals who require flexibility in their planter-related displays must keep large numbers of planters on hand to assure the necessary diversity in their displays.

Yet another disadvantage associated with traditional planters is that the planters are not configured to provide a temporary barrier around fixed objects such as trees, mailboxes, and lampposts. Such a temporary barrier would be especially useful in protecting fragile seasonal flower arrangements from the hazards of foot traffic, lawnmowers, bicycles, and canine urination.

Accordingly, there is a need for an improved planter that is lightweight and easy to store, and that is configured to be easily assembled around fixed objects such as trees, mailboxes, and lampposts. Preferably, the improved planter would be configured so that its size and shape could be adjusted as needed for any of multiple uses.

### BRIEF SUMMARY OF THE INVENTION

Various embodiments of present invention are directed to methods for using an improved planter that is lightweight and easy to store, and that is configured to be easily assembled around fixed objects such as trees, mailboxes, and lampposts. In one embodiment of the invention, the improved planter is configured so that its size and shape can be adjusted as needed for any of multiple uses.

A method, according to various embodiments of the invention, for providing a planter arrangement adjacent a stationary object that extends into the ground comprises the steps of: (A) providing a modular planter kit that comprises: (1) a first panel having a first lateral side and a second lateral side; (2) a second panel having a first lateral side and a second lateral side; (3) a third panel having a first lateral side and a second lateral side; (4) a fourth panel having a first lateral side and a second lateral side; (5) a first, temporary fastener that is configured for temporarily attaching the first panel adjacent the second panel so that the second lateral side of the first panel is immediately adjacent the first lateral side of the second panel; (6) a second, temporary fastener that is configured for temporarily attaching the third panel adjacent the second panel so that the first lateral side of the third panel is immediately adjacent the second lateral side of the second panel; (7) a third, temporary fastener that is configured for temporarily attaching the fourth panel adjacent the third panel so that the first lateral side of the fourth panel is immediately adjacent the second lateral side of the third panel.

In particular embodiments: (1) the first, temporary fastener comprises a first outwardly extending male fastener portion and a first female fastener portion; (2) the first, temporary fastener is adapted to removably attach the first panel adjacent the second panel via a frictional engagement between the first male fastener portion and the first female fastener portion, (3) the second, temporary fastener comprises a second outwardly extending male fastener portion and a second female fastener portion; (4) the second, temporary fastener is adapted to removably attach the third panel adjacent the second panel via a frictional engagement between the second male fastener portion and the second female fastener portion; (5) the third, temporary fastener comprises a third outwardly extending male fastener portion and a third female fastener portion; and (6) the third, temporary fastener is adapted to removably attach the fourth panel adjacent the third panel via a frictional engagement between the outwardly extending third male fastener portion and the third female fastener portion.

In various embodiments, the method includes the step of assembling the modular planter kit so that: (1) the first, temporary fastener temporarily attaches the first panel adjacent the second panel so that the second lateral side of the first panel is immediately adjacent the first lateral side of the second panel; (2) the second, temporary fastener temporarily attaches the third panel adjacent the second panel so that the first lateral side of the third panel is immediately adjacent the second lateral side of the second panel; (3) the third, temporary fastener temporarily attaches the fourth panel adjacent the third panel so that the first lateral side of the fourth panel is immediately adjacent the second lateral side of the third panel; and (4) the first, second, third, and fourth panels at least substantially surround a base portion of the stationary object that extends into the ground.

### BRIEF DESCRIPTION OF THE DRAWINGS

Having thus described the invention in general terms, reference will now be made to the accompanying drawings, which are not necessarily drawn to scale, and wherein:

FIG. 1 is a top view of a planter according to one embodiment of the invention.

FIG. 2A is a perspective view of the planter of FIG. 1.

FIG. 2B is a perspective view of an alternative embodiment of the planter of FIG. 1 that includes additional decorative features. This figure shows the planter assembled around a mailbox and filled with decorative plants.

FIG. 2C is a top view of the planter of FIG. 1.

FIG. 3A is a top view of a hinged, two-panel assembly in a closed “storage configuration”.

FIG. 3B is a top view of a planter according to yet another embodiment of the invention.

FIG. 3C is a top view of a planter according to a further embodiment of the invention.

FIG. 3D is a top view of a planter according to yet another embodiment of the invention.

FIG. 4 is a perspective view of the planter of FIG. 1.

FIG. 5A is a top view of a modular planter in a four-panel, four-post configuration.

FIG. 5B is a top view of a modular planter in a four-panel, four-post configuration with two different sized panels.

FIG. 5C is a top view of a modular planter in a six-panel, six-post configuration.

FIG. 6A is a top view of a modular planter in an eight-panel, eight-post configuration.

FIG. 6B is a top view of a modular planter in a four-panel, five-post configuration in which a wall or other substantially vertical surface is used as a fourth side of the planter.

FIG. 6C is a top view of a modular planter in a four-panel, four-post configuration in which a wall or other substantially vertical surface is used as a fourth side of the planter. The end posts are each formed by half of a single post.

FIG. 7A is a top view of a modular planter that includes two straight panels and two rounded panels.

FIG. 7B is a top view of a modular planter that includes six panels and four posts.

FIG. 8 is a front view of two panels showing that, in a particular embodiment of the invention, posts may be built into the individual panels so that each panel includes one or two posts.

FIG. 9A is a top view of a three-panel planter according to a particular embodiment of the invention in which hook and eye fasteners are used to hold the panels together.

FIG. 9B is a top view of a three-panel planter according to one embodiment of the invention in which a wall or other substantially vertical surface is used as a fourth side of the planter.

FIG. 10 is a perspective view of a two-panel planter according to another embodiment of the invention in which a wall or other substantially vertical surface is used as a third side of the planter.

FIG. 11 is a top perspective view of a four-panel planter according to another embodiment of the invention.

FIG. 12 is a perspective view of two panels of the planter of FIG. 11. This view shows the fasteners that are used to attach the panels adjacent one another.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Overview

As noted above, a planter according to one embodiment of the invention comprises one or more side panels (“panels”), and a bottom portion that defines an opening that provides a passage between: (1) an interior portion defined by the side panels; and (2) an exterior area that is outside of the interior of the planter and immediately adjacent the bottom portion of the planter. In a particular embodiment of the invention, the planter has no substantial bottom portion (i.e., is bottomless). In one embodiment of the invention, the planter includes supports (which are preferably vertical posts) for connecting at least two of the side panels, and for providing structural support to the planter. The planter also preferably comprises an anchoring system for providing additional stability if needed.

The planter is preferably configured so that it may be set up so that it surrounds the base of a stationary object (such as a mailbox, lantern, or pole) that extends at least partially into the ground. Alternatively, the planter may be set up so that it does not surround a stationary object. After the planter is set up, it is filled with dirt and plants (or other decorative vegetation) like a regular planter. However, because the planter defines an opening in its bottom portion, plants can root directly into the ground through the opening. This minimizes the need for constant watering.

Alternatively, the planter may be filled with potted plants or flowers. This is especially useful when the planter is being used as part of a temporary display (e.g., when the planter is rented out for a particular event by an event planner).

In one embodiment of the invention, the planter is constructed of robust materials, such as solid wood. In this embodiment of the invention, the height of the individual side panels is between about 10 to 12 inches. As a result, the housing is configured to provide a protective barrier that protects the plants from canine urination and other potentially damaging events.

Bottomless planters according to the invention are configured for use by, for example, event planners and exhibitors. The planters are particularly useful in forming temporary displays in trade or flower shows, or vignettes used in wholesale/retail establishments. The planters are preferably configured to stand alone on the ground or other hard surface. The planters may also include an open side, and may adapted to be positioned adjacent a substantially vertical wall so that the open side is closed by the vertical wall.

In one embodiment of the invention, a planter is configured so that it may be positioned to substantially (and preferably entirely) surround one or more tent poles or tent stakes. This serves to prevent people from inadvertently tripping over the tent poles or stakes. In another embodiment of the invention, the panels of the planter are preferably large enough so that they can be set up to surround one or more tent support barrels or trash cans, and to obstruct pedestrians from running into these support barrels or trash cans.

In a further embodiment of the invention, the planter is configured to support an interior liner (such as a plastic garbage bag) within the interior of the planter. This allows the planter to be used as a decorative garbage can.

In yet another embodiment of the invention, the planter is dimensioned so that it can be set up to at least substantially (and preferably completely) surround the base of an indoor Christmas tree. Preferably, the planter is configured so that, after it is set up, it hides the Christmas tree's tree stand from nearby viewers. In this embodiment of the invention, at least one of the planter's side panels is preferably configured to function as a “door panel”, as discussed in detail below, to facilitate access to the base of the tree.

Because, in one embodiment, the bottomless planter can be folded and/or disassembled, event planners, exhibitors and other users may store and transport many more of these planters within a particular space than would be possible using traditional planters with bottoms. This makes it easier to set the planters up at events, flower shows, trade shows or vignettes in wholesale/retail establishments.

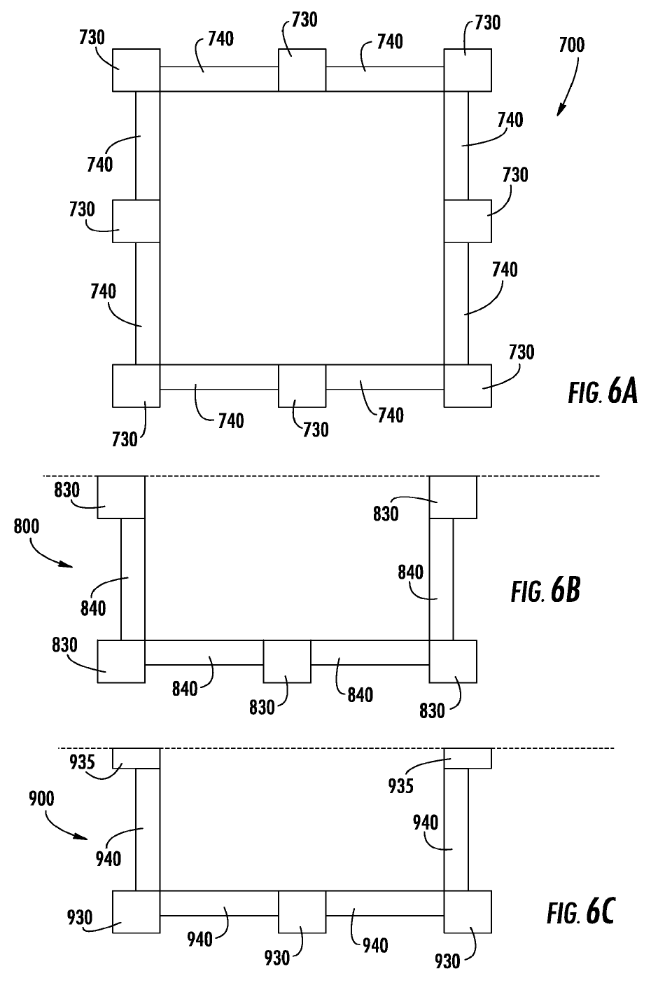

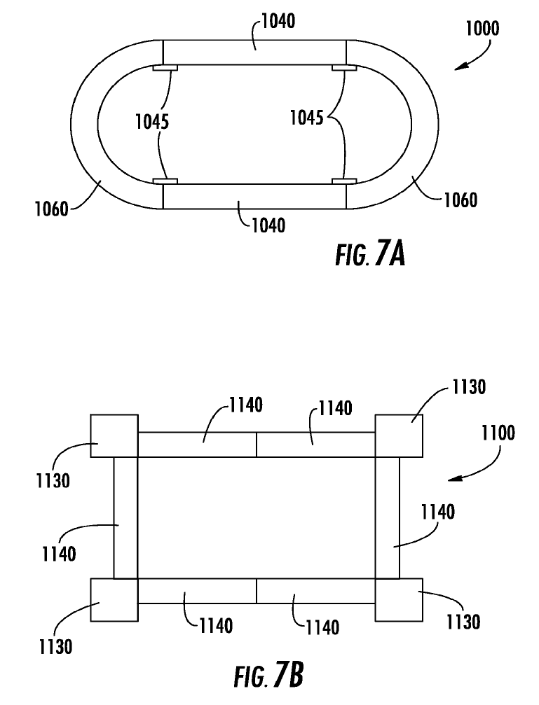

Because a planter according to one embodiment of the invention is assembled using individual, modular panels, the individual panels can be assembled in any of a variety of different configurations (e.g., in square, rectangular, or polygonal configurations). By the same token, in one embodiment of the invention, a wall or other vertical surface may be used in place of a panel. Thus, for example, a four sided assembly may be created by forming a three-sided structure with an open end, and then positioning the three-sided structure so that its open end is immediately adjacent a wall. (See, for example, FIG. 6B). In another embodiment of the invention, one or more of the planter's individual panels is curved. (See, for example, FIG. 7A)

Detailed Discussion

In one embodiment of the invention, the planter comprises four modular, rectangular, substantially planar panels that are configured to be easily assembled to form a generally rectangular (and preferably square), substantially bottomless enclosure.

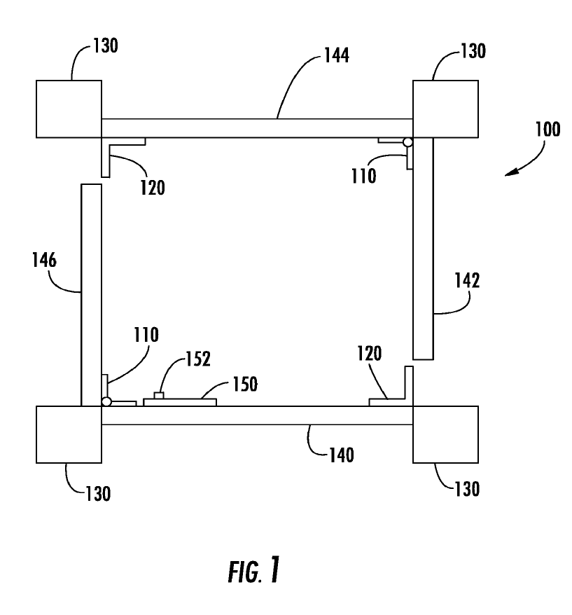

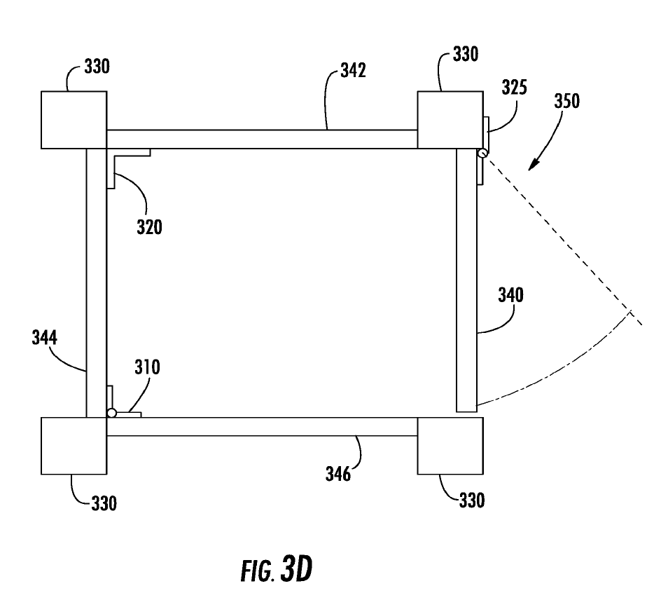

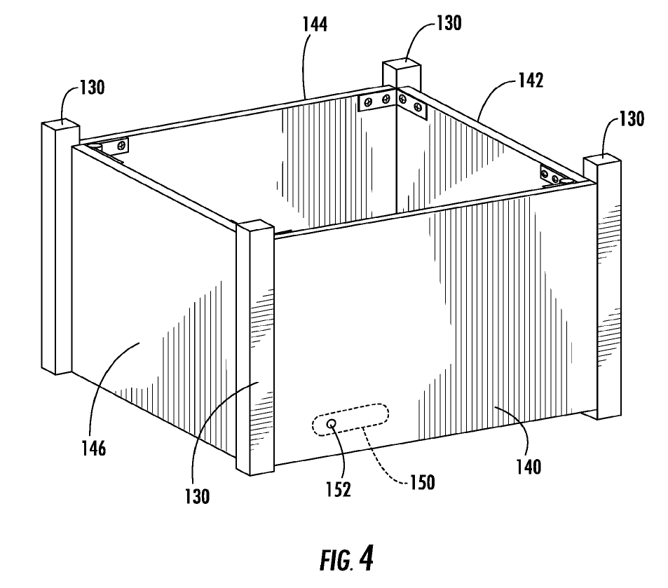

A planter 100 according to one embodiment of the invention is shown in FIGS. 1, 2A, 2C and 4. As may be understood from these figures, in this embodiment of the invention, the planter 100 comprises a front panel 140, two side panels 142, 146, and a rear panel 144. These panels 140, 142, 144, 146 are preferably attached together to form a solid, substantially bottomless, box with a substantially open top. In a preferred embodiment of the invention, the planter 100 has no bottom, but in an alternative embodiment of the invention, the planter 100 has a partial bottom that defines an opening through which the roots of plants within the planter 100 may extend into the ground beneath the planter 100.

In a preferred embodiment of the invention, the planter 100 includes one or more, preferably vertical, supports (e.g., posts) 130 for structurally reinforcing the planter 100. As shown in FIG. 1, these supports 130 are preferably positioned at the intersection of two adjacent panels 140, 142, 144, 146, but may be located at any suitable position on the planter 100. In one embodiment of the invention, one or more of the panels 140, 142, 144, 146 includes an integrated support.

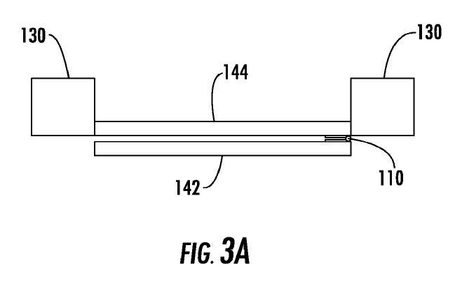

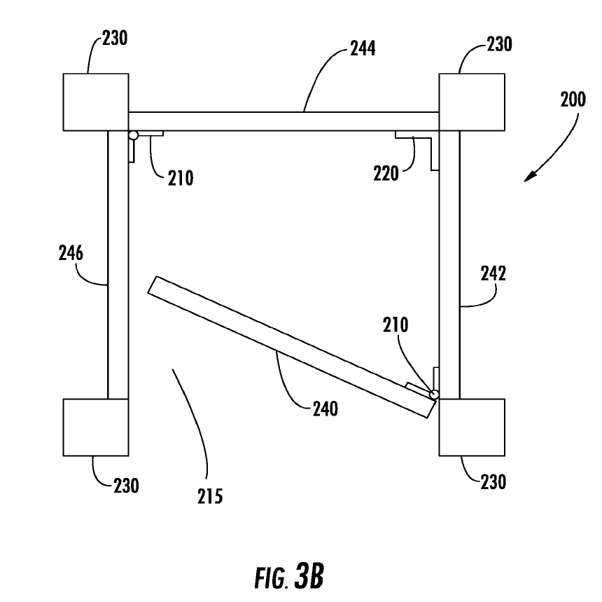

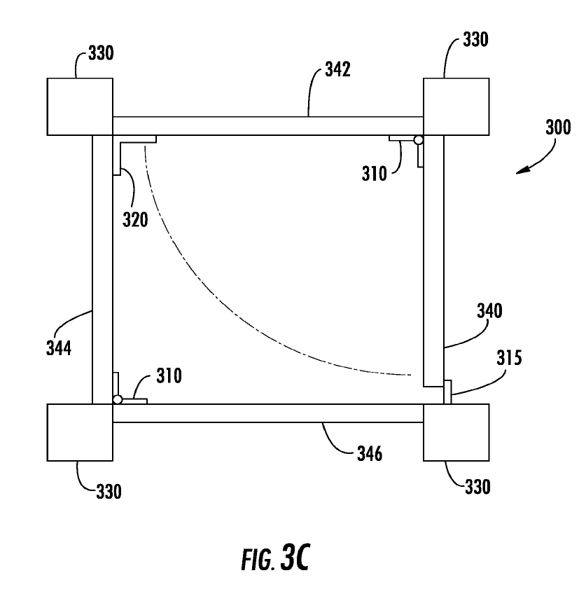

In the embodiment of the invention shown in FIGS. 1, 2A, 2C, and 4, the front panel 140 and the first side panel 146 are permanently attached along their mating side edges via one or more hinges 110. Similarly, the rear panel 144 and second side panel 142 are also permanently attached along their mating side edges via one or more hinges 110. This allows the planter 100 to be disassembled into two, hinged two-panel assemblies. As shown in FIG. 3A, these two-panel assemblies may be folded about the hinges 110 so that the two panels 142, 144 “close” into a substantially flat, storage configuration.

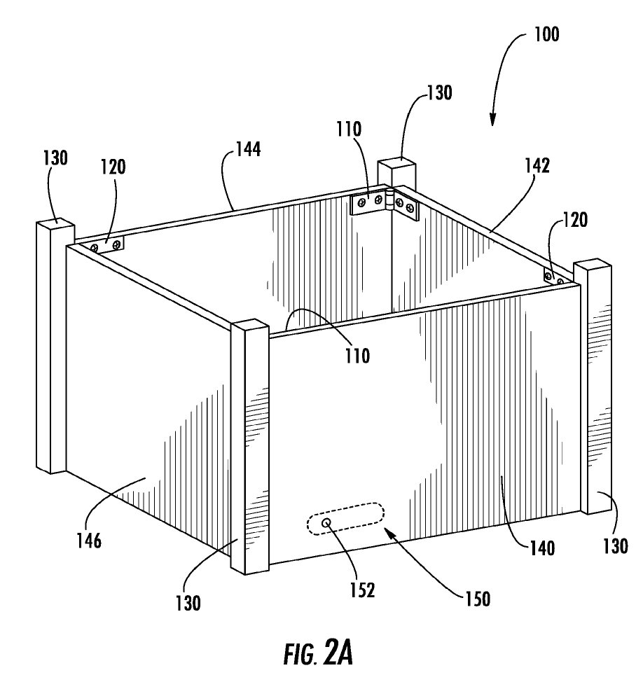

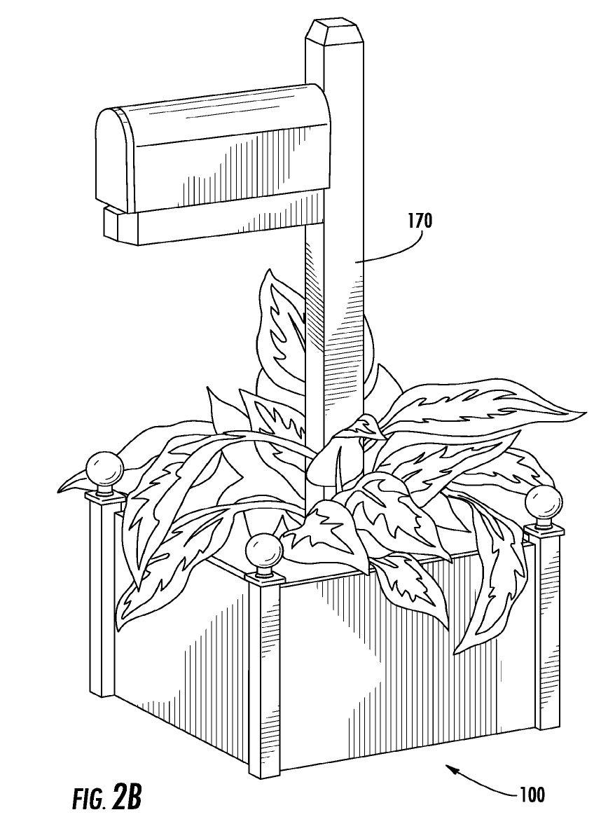

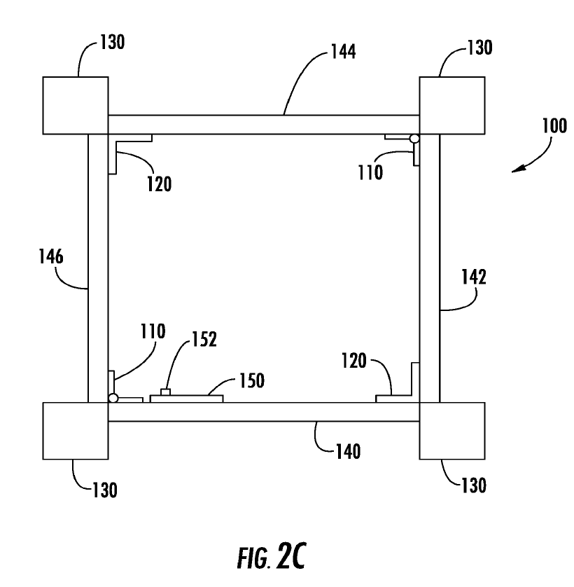

As may be understood from FIGS. 1, 2A, 2B, 2C and 4, the two, two-panel assemblies may be positioned around a stationary object (such as a mailbox assembly 170 that includes a mailbox post and a mailbox as shown in FIG. 2B) to form a contiguous enclosure. The two-panel assemblies are then preferably attached to one another using one or more suitable fasteners (e.g., brackets, hook/eye fasteners, Velcro) as known in the art.

FIG. 3B depicts an embodiment of the invention having four panels 240, 242, 244, 246 that include support posts 230. As may be understood from this figure, one side of one of the planter's panels 240 is mounted to the rest of the planter 200 via a hinge 210, and the opposite side of that panel 240 is not fixedly attached to the rest of the planter 200. This allows users to swing that particular panel 240 (which may be referred to as a “door panel”) inwardly (or, alternatively, outwardly—see FIG. 3D) relative to the rest of the planter 200. This creates a gap 215 for receiving a fixed object into the interior of the planter 200. This allows users to quickly place the planter 200 around fixed objects by: (1) moving the door panel 240 into an open position in which the door panel 240 at least partially defines a gap 215 for receiving a fixed object into the interior of the planter 200; (2) moving the planter 200 relative to a substantially fixed object (such as a mailbox post, tree, or tent stake) so that the fixed object passes through the gap 215 and into the interior of the planter 200; and (3) moving the door panel 240 from the open position to a closed position so that the door panel 240 substantially closes the gap 215. In a preferred embodiment of the invention, the door panel 240 is then locked in place (e.g., via an eye/hook fastener or other suitable fastener) to assure that the door panel 240 is not inadvertently opened during use.

A further embodiment of the invention includes modular panels that may be assembled together with or without supports to form planters of varying size and shape. These modular panels include fasteners that allow each panel to be connected to an adjacent panel along common side edges of the panels so that the panels form an angle. In a preferred embodiment of the invention, this angle is preferably about either 90 or 180 degrees. However, this angle may be any other suitable angle.

In one embodiment of the invention, a plurality of the modular panels are equipped with one or more fasteners that allow each panel to be connected (e.g., temporarily connected) to any one of a plurality of other panels. For example, in one embodiment of the invention, at least one male fastener is provided adjacent the right side edge of each panel and at least one female fastener is provided adjacent the left side edge of each panel. In this embodiment of the invention, the panels are preferably configured so that the right side edge of any particular panel may be connected to the left side edge of any one of a plurality of the planter's other panels. In a preferred embodiment of the invention, this plurality includes all of the planter's other panels.

Similarly, the panels are preferably configured so that the left side edge of any particular panel may be connected to the right side edge of any one of a plurality of the planter's other panels. In a preferred embodiment of the invention, this plurality includes all of the planter's other panels. This modular aspect of this embodiment of the invention makes it possible for users to use a single grouping (or “kit”) of panels to form many different sizes, configurations, and types of planters.

A planter kit according to one embodiment of the invention includes one or more supports. In this embodiment of the invention, either the posts, the panels, or both the posts and panels are equipped with fasteners that allow any particular two of at least three (and preferably any of) the planter's panels to be attached to any one of at least two (and preferably any of) the planter's supports. This allows a user to assemble planters of varying size and shape using different numbers of panels and posts.

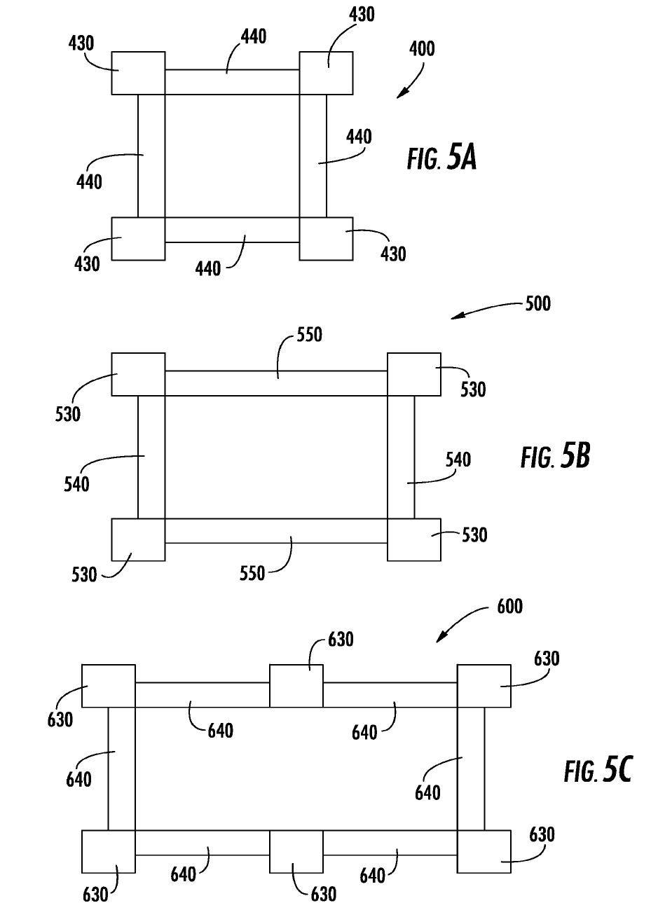

For example, as shown in FIG. 5A, a user may use four (preferably substantially identical) panels 440 and four supports 430 to form a small square planter. Similarly, as shown in FIG. 5B, a user may use two large panels 550 and two small panels 540 and four supports 530 to form a substantially rectangular planter. Furthermore, as shown in FIG. 5C, a user may use six substantially equally sized (and preferably substantially structurally identical) panels 640 and six supports 630 to form a larger rectangular planter.

FIGS. 6A-6C depict top views of three different modular planters. The planter 700 shown in 6A comprises eight (preferably substantially structurally identical) modular panels 740 and eight supports 730, and is in the form of a large square. The planters shown in FIGS. 6B and 6C are each three-sided planters. The planter shown in FIG. 6B comprises four (preferably substantially structurally identical) modular panels 840 and five posts 830, and the planter 900 shown in FIG. 6C comprises four (preferably substantially structurally identical) panels 940, three full posts 930 and two half-posts 935.

As noted above, the planter's various panels may, for example, be either substantially planar, or curved. For example, a planter according to one embodiment of the invention, which is shown in FIG. 7A, comprises two substantially planar panels 1040 and two curved panels 1060. On the other hand, a planter 1100 according to another embodiment of the invention, which is shown in FIG. 7B, comprises six substantially planar panels 1140 and four supports 1130.

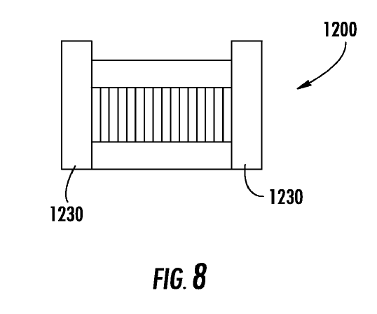

As also noted above, the planter's various supports 1130 may either be separate from, or integrated into, the planter's various panels. For example, a panel 1200 according to one embodiment of the invention in which two supports 1230 are integrated into each panel 1200 is shown in FIG. 8.

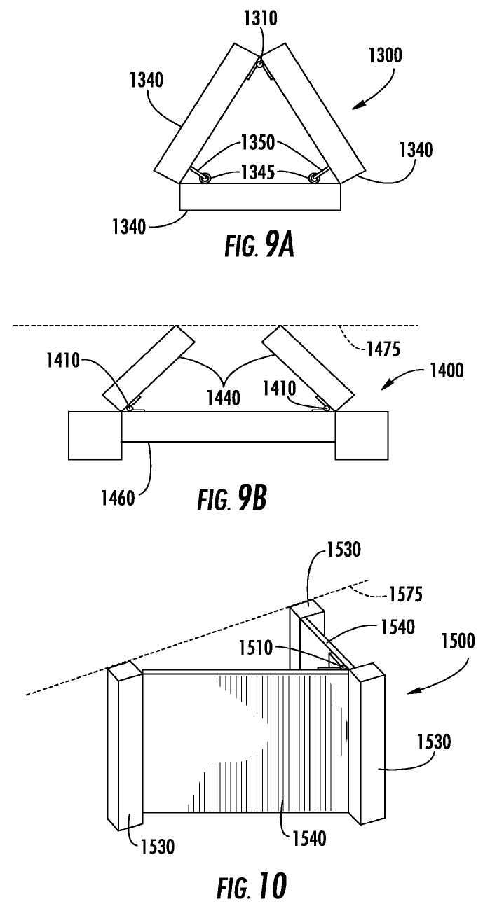

As may be understood from FIGS. 9A and 9B, varying the angle between two identically or differently sized panels allows for irregularly shaped bottomless planters. FIG. 9A depicts a top view of a three-sided triangular planter 1300. FIG. 9B depicts a top view of a three-sided planter 1400 that comprises two short panels 1440 that are attached adjacent opposite ends of a longer panel 1460 via hinges 1410. As may be understood from this figure, this planter 1400 may be positioned against a substantially vertical surface 1475, which serves to obstruct an open end of the planter 1400.

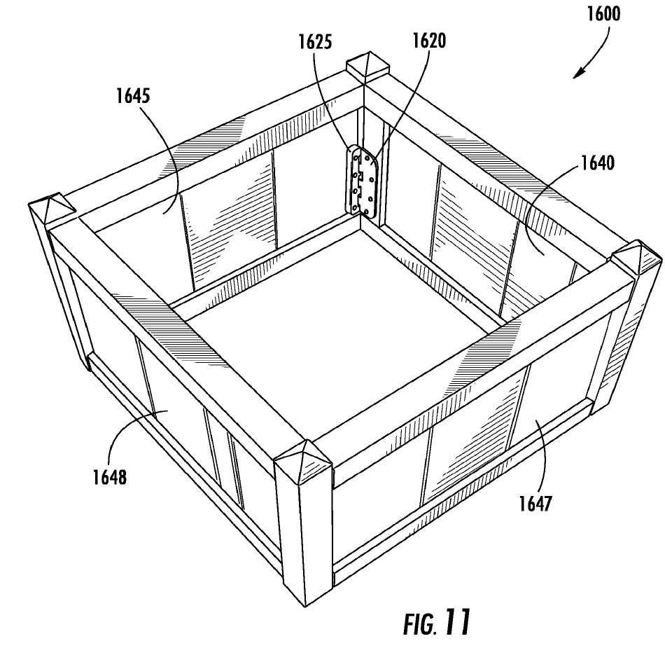

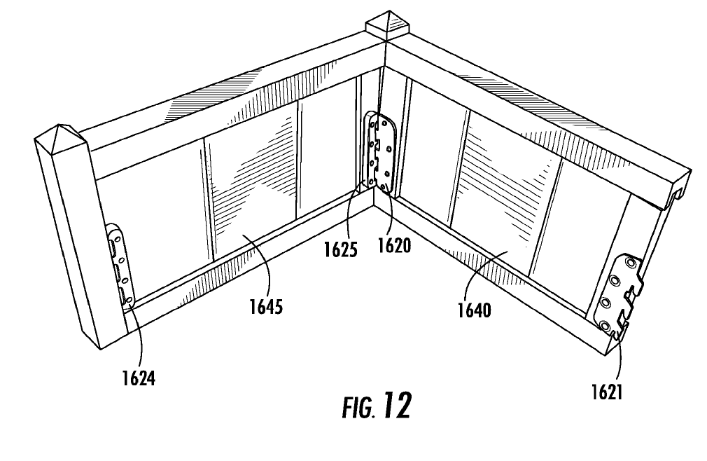

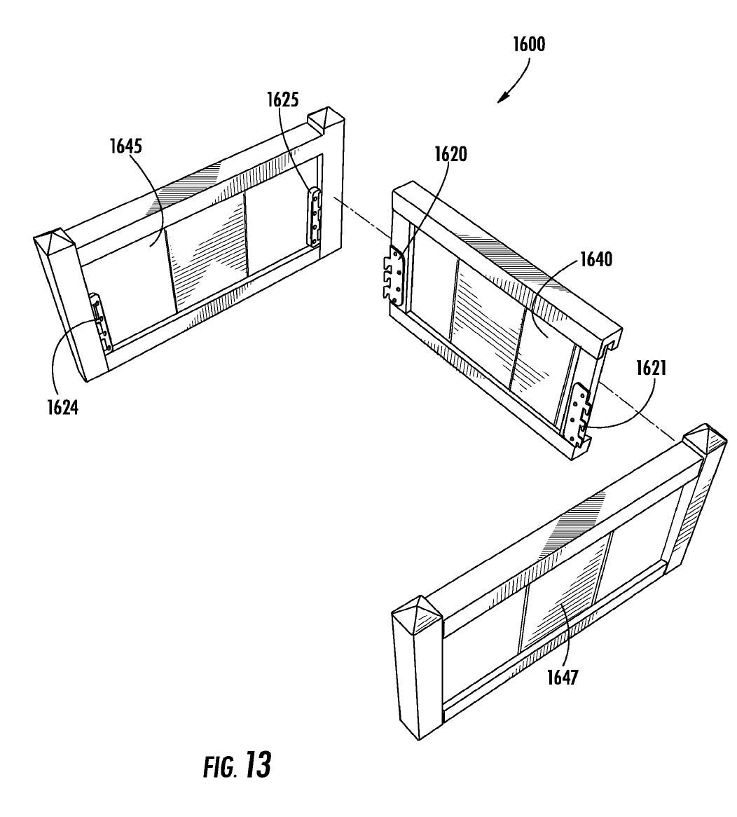

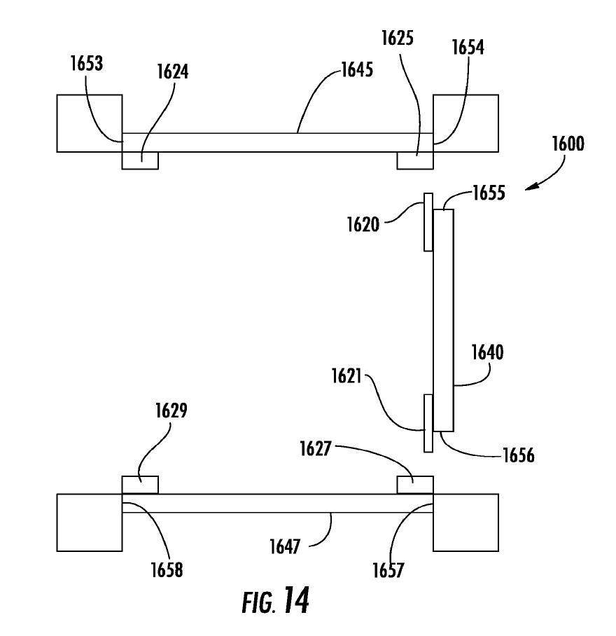

FIG. 10 shows a planter 1500 according to one embodiment of the invention in which the planter 1500 comprises two panels 1540 and three posts 1530. The panels 1540 are attached together (preferably via a hinge) so that the panels 1540 may be rotated relative to each other to modify the angle formed by the two panels 1540. As shown in FIG. 10, the planter 1500 may be positioned adjacent a vertical, substantially planar surface 1575 so that the vertical surface 1575 serves to obstruct an open end of the planter 1500.

As noted above, a planter according to various embodiments of the invention may be assembled using any number of panels, or panels and supports, depending on the desired size and shape of the planter. The panels and/or supports are preferably attached together by fasteners such as screws, hinges, brackets, hook/eye fasteners, slide bolts, Velcro, or other fasteners known in the art.

In one embodiment of the invention, an example of which is shown in FIGS. 1, 2A, 2C, and 4, at least one of the panels 140, 142, 144, 146 includes a stake or other anchoring device 150. This anchoring device 150 is mounted to be rotated (e.g., about pivot point 152) or slid between a first position, in which the anchoring device 150 is immediately adjacent the panel 140, 142, 144, 146, and a second position in which the anchoring device 150 is projecting downwardly from the bottom edge of the panel 140, 142, 144, 146. When in the second position, the anchoring device 150 may be pushed into the ground or other surface to hold the panel 140, 142, 144, 146 in place. When the anchoring device 150 is not needed, it may be moved into the first position for convenient and unobtrusive storage. In one embodiment of the invention, the planter 100 includes a plurality of anchoring devices 150 to hold the planter 100 securely in place.

Each panel and/or support may be designed in any desired motif (plain, paneled, missionary, classical, etc.) and made preferably out of any appropriate building material (e.g., wood, composite vinyl, plastic). The height, width, depth, and overall shape of the panels and supports may vary depending on the planter's intended use.

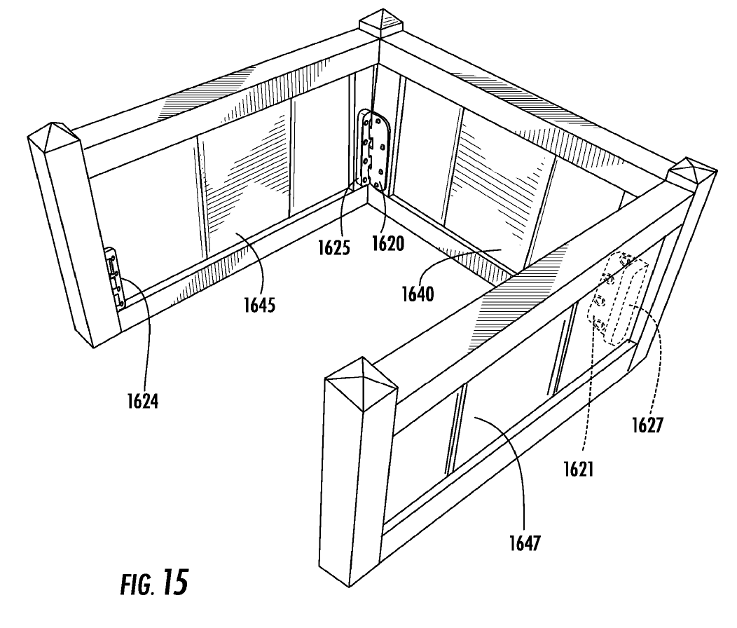

Similarly, the fasteners that are used to attach the various panels together may take many different forms. For example, in one embodiment of the invention, the various fasteners may comprise hinges that are used to fixedly and pivotably attach two or more of the panels adjacent one another. In another embodiment of the invention, such as the embodiment shown in FIGS. 11 and 12, the various fasteners may comprise one or more two-part fasteners, each of which includes a male fastener portion 1620 and a female fastener portion 1625.

In the embodiment of the invention shown in FIGS. 11 and 12, each female fastener portion 1625 includes one or more slots, and each male fastener portion 1620 includes one or more hooked male members. In one embodiment of the invention, at least one of the hooked male members is adapted to be received within a corresponding one of the female portion's slots, and to slideably engage the female fastener portion 1625 after the hooked male member is received within that slot and pushed downwardly relative to the female fastener portion 1625. This causes the male fastener portion 1620 to releasably hook onto the female fastener portion 1625.

In one embodiment of the invention shown in FIGS. 11 and 12, the planter 1600 comprises four panels 1640, 1645. As may be understood from these figures, two of the panels 1640 (which may be referred to as “male” panels) include two male fastener portions 1620; one of which extends outwardly from a first side edge of the male panel 1640, and another of which extends outwardly from a second side edge of the male panel 1640. Similarly, two of the panels 1645 (which may be referred to as “female” panels) include two female fastener portions 1625; one of which is positioned adjacent a first side edge of the “female” panel 1645, and another of which is positioned adjacent a second side edge of the “female” panel 1645. In this embodiment of the invention, the planter 1600 is assembled by positioning the male fastener portions 1620 of the two “male” panels 1640 so that they slideably engage the female fastener portions 1625 of the two “female” panels 1645 as described above. The planter 1600 may later be disassembled by hand, and without using tools, by sliding the “male” panels 1640 upwardly relative to the “female” panels 1645 and then pulling the “male” panels 1640 away from the “female” panels 1645.

### CONCLUSION

Many modifications and other embodiments of the invention will come to mind to one skilled in the field to which this invention pertains having the benefit of the teachings presented in the foregoing descriptions and the associated drawings. For example, it should be understood in light of the above disclosure that certain embodiments of the invention involving an entirely bottomless planter may also be configured to include a planter that defines a partial bottom. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of providing a planter arrangement adjacent a stationary object that extends into the ground, said method comprising the steps of:
(A) providing a modular planter kit that comprises:
a first panel having a first lateral side and a second lateral side;
a second panel having a first lateral side and a second lateral side;
a third panel having a first lateral side and a second lateral side;
a fourth panel having a first lateral side and a second lateral side;
a first, temporary fastener that is configured for temporarily attaching said first panel adjacent said second panel so that said second lateral side of said first panel is immediately adjacent said first lateral side of said second panel;
a second, temporary fastener that is configured for temporarily attaching said third panel adjacent said second panel so that said first lateral side of said third panel is immediately adjacent said second lateral side of said second panel;
a third, temporary fastener that is configured for temporarily attaching said fourth panel adjacent said third panel so that said first lateral side of said fourth panel is immediately adjacent said second lateral side of said third panel, wherein:
said first, temporary fastener comprises a first outwardly extending male fastener portion and a first female fastener portion,
said first, temporary fastener is adapted to removably attach said first panel adjacent said second panel via a frictional engagement between said first male fastener portion and said first female fastener portion,
said second, temporary fastener comprises a second outwardly extending male fastener portion and a second female fastener portion,
said second, temporary fastener is adapted to removably attach said third panel adjacent said second panel via a frictional engagement between said second male fastener portion and said second female fastener portion;
said third, temporary fastener comprises a third outwardly extending male fastener portion and a third female fastener portion, and
said third, temporary fastener is adapted to removably attach said fourth panel adjacent said third panel via a frictional engagement between said outwardly extending third male fastener portion and said third female fastener portion;
(B) assembling said modular planter kit so that:
said first, temporary fastener temporarily attaches said first panel adjacent said second panel so that said second lateral side of said first panel is immediately adjacent said first lateral side of said second panel;
said second, temporary fastener temporarily attaches said third panel adjacent said second panel so that said first lateral side of said third panel is immediately adjacent said second lateral side of said second panel;
said third, temporary fastener temporarily attaches said fourth panel adjacent said third panel so that said first lateral side of said fourth panel is immediately adjacent said second lateral side of said third panel; and
said first, second, third, and fourth panels at least substantially surround a base portion of said stationary object that extends into the ground.

2. The method of claim 2, wherein said stationary object is a mailbox post.

3. The method of claim 1, further comprising the step of, after assembling said modular planter kit, placing an arrangement of plants adjacent said stationary object and within a perimeter defined by said first, second, third, and fourth panels.

4. The method of claim 3, wherein said stationary object is a mailbox post.

5. The method of claim 1, wherein said first, second, third, and fourth panels surround the base of said stationary object that extends into the ground.

6. The method of claim 1, wherein each of said first, second, third, and fourth panels is substantially planar.

7. The method of claim 1, wherein:
said first fastener is adapted to allow a user to attach said first panel adjacent said second panel by moving said first male portion of said first fastener so that said first male portion of said first fastener slideably engages said first female portion of said first fastener; and
said step of assembling said modular planter kit comprises attaching said first panel adjacent said second panel by moving said first male portion of said first fastener so that said first male portion of said first fastener slideably engages said first female portion of said first fastener.

8. The method of claim 7, wherein:
said second fastener is adapted to allow a user to attach said third panel adjacent said second panel by moving said second male portion of said second fastener so that it slideably engages said second female portion of said second fastener; and
said step of assembling said modular planter kit comprises attaching said third panel adjacent said second panel by moving said second male portion of said second fastener so that it slideably engages said second female portion of said second fastener.

9. The method of claim 1, wherein said modular planter kit further comprises an anchor that is attached adjacent at least one of said first, second, third, or fourth panels, said anchor being adapted to be driven into a supporting surface after said modular planter kit is assembled and positioned on said supporting surface; and
said step of assembling said modular planter kit comprises diving said anchor into said supporting surface after said modular planter kit is assembled and positioned on said supporting surface.

10. The method of claim 1, wherein a height of each of said panels is between about 10 and 12 inches.

11. The method of claim 1, wherein:
said first, second, third, and fourth panels are adapted to be stacked when not in use; and
said method comprises disassembling said modular planter kit and stacking said first, second, third, and fourth panels.

12. The method of claim 1, wherein:
said first male fastener portion is attached adjacent said first lateral side of said second panel;
said first female fastener portion is attached adjacent said second lateral side of said first panel;
said second male fastener portion is attached adjacent said second lateral side of said second panel; and
said second female fastener portion is attached adjacent said first lateral side of said third panel.

13. The method of claim 1, wherein:
said first female fastener portion comprises a first slot; and
said first outwardly extending male fastener portion comprises a first hooked male member that is adapted to slideably engage said first female fastener portion, and to thereby releasably hook onto said first female fastener portion after said first hooked male member is received within said first slot and pushed downwardly relative to said first female fastener portion.

14. The method of claim 1, wherein:
said second female fastener portion comprises a second slot; and
said second outwardly extending male fastener portion comprises a second hooked male member that is adapted to slideably engage said second female fastener portion, and to thereby releasably hook onto said second female fastener portion after said second hooked male member is received within said second slot and pushed downwardly relative to said second female fastener portion.

15. The method of claim 1, wherein:
said first female fastener portion comprises a first slot;
said first outwardly extending male fastener portion comprises a first hooked male member that is adapted to slideably engage said first female fastener portion, and to thereby releasably hook onto said first female fastener portion after said first hooked male member is received within said first slot and pushed downwardly relative to said first female fastener portion;
said second female fastener portion comprises a second slot; and
said second outwardly extending male fastener portion comprises a second hooked male member that is adapted to slideably engage said second female fastener portion, and to thereby releasably hook onto said second female fastener portion after said second hooked male member is received within said second slot and pushed downwardly relative to said second female fastener portion.

16. The method of claim 1, wherein:
said first female fastener portion comprises a first slot;
said first outwardly extending male fastener portion comprises a first hooked male member that is adapted to slideably engage said first female fastener portion, and to thereby releasably hook onto said first female fastener portion after said first hooked male member is received within said first slot and pushed downwardly relative to said first female fastener portion;
said second female fastener portion comprises a second slot;
said second outwardly extending male fastener portion comprises a second hooked male member that is adapted to slideably engage said second female fastener portion, and to thereby releasably hook onto said second female fastener portion after said second hooked male member is received within said second slot and pushed downwardly relative to said second female fastener portion;
said third female fastener portion comprises a third slot; and
said third outwardly extending male fastener portion comprises a third hooked male member that is adapted to slideably engage said third female fastener portion, and to thereby releasably hook onto said third female fastener portion after said third hooked male member is received within said third slot and pushed downwardly relative to said third female fastener portion.

17. The method of claim 1, wherein:
said first, second, third, and fourth panels are adapted to be attached together to form a substantially bottomless box with a substantially open top.

18. The method of claim 1, wherein:
said modular planter kit further comprises
a fourth, temporary fastener that is configured for temporarily attaching said fourth panel adjacent said third panel so that said second lateral side of said fourth panel is immediately adjacent said first lateral side of said first panel, wherein:
said fourth, temporary fastener comprises a fourth outwardly extending male fastener portion and a fourth female fastener portion, and
said fourth temporary fastener is adapted to removably attach said fourth panel adjacent said first panel via a frictional engagement between said outwardly extending fourth male fastener portion and said fourth female fastener portion.

19. A method of providing a planter arrangement adjacent a stationary object stationary object that extends into the ground, said method comprising the steps of:
(A) providing a modular planter kit that comprises:
a first panel having a first lateral side and a second lateral side;
a second panel having a first lateral side and a second lateral side;
a third panel having a first lateral side and a second lateral side;
a fourth panel having a first lateral side and a second lateral side;
a first, temporary fastener that is configured for temporarily attaching said first panel adjacent said second panel so that said second lateral side of said first panel is immediately adjacent said first lateral side of said second panel;
a second fastener that is configured for attaching said third panel adjacent said second panel so that said first lateral side of said third panel is immediately adjacent said second lateral side of said second panel;
a third, temporary fastener that is configured for temporarily attaching said fourth panel adjacent said third panel so that said first lateral side of said fourth panel is immediately adjacent said second lateral side of said third panel, wherein:
said first, temporary fastener comprises a first outwardly extending male fastener portion and a first female fastener portion,
said first, temporary fastener is adapted to removably attach said first panel adjacent said second panel via a frictional engagement between said first male fastener portion and said first female fastener portion,
said second fastener comprises a hinge;
said third, temporary fastener comprises a third outwardly extending male fastener portion and a third female fastener portion, and
said third, temporary fastener is adapted to removably attach said fourth panel adjacent said third panel via a frictional engagement between said outwardly extending third male fastener portion and said third female fastener portion;
(B) assembling said modular planter kit so that:
said first, temporary fastener temporarily attaches said first panel adjacent said second panel so that said second lateral side of said first panel is immediately adjacent said first lateral side of said second panel;
said second fastener attaches said third panel adjacent said second panel so that said first lateral side of said third panel is immediately adjacent said second lateral side of said second panel;
said third, temporary fastener temporarily attaches said fourth panel adjacent said third panel so that said first lateral side of said fourth panel is immediately adjacent said second lateral side of said third panel; and
said first, second, third, and fourth panels at least substantially surround the base of said stationary object that extends into the ground.

20. The method of claim 19, wherein:
said modular planter kit further comprises a fourth fastener that is configured for attaching said fourth panel adjacent said third panel so that said second lateral side of said fourth panel is immediately adjacent said first lateral side of said first panel; and
said fourth fastener comprises a hinge.
